(19) United States
(12) Patent Application Publication
(10) Pub. No.: US 2005/0151828 A1
(43) Pub. Date: Jul. 14, 2005

(54) Xerographic printing system with VCSEL-micro-optic laser printbar

(75) Inventor: Patrick Y. Maeda, Mountainview, CA (US)

Correspondence Address: Gunnar G. Leinberg, Esq.;Nixon Peabody LLP, Clinton Square, P.O. Box 31051, Rochester, NY, 14603-1051, US

(73) Assignee: Xerox Corporation.

(21) Appl. No.: 10/757,274

(22) Filed: Jan. 14, 2004

(51) Int. Cl. B41J 2/45

(52) U.S. Cl. 347/238

(57) ABSTRACT

A micro-optic light emitting array has a plurality of vertical cavity surface emitting lasers focused with micro-optics. The present invention also provides a laser printbar assembly having of a plurality of such micro-optic light emitting arrays and a xerographic printing system including the laser printbar imager assembly which emits a plurality of laser light beams, a photoreceptor for receiving emitted light and for holding a toner image, and xerographic developer for exposing areas of the photoreceptor to emitted light from the printbar imager assembly. Also provided is a laser multifunction system having the laser printbar imager assembly of the invention including a plurality of micro-optic light emitting arrays as described above.

### FIELD

This invention relates generally to a xerographic laser printing system and, more particularly, to a laser printbar assembly including a plurality of Vertical Cavity Surface Emitting Laser (“VCSEL”) arrays with micro-optic lenses to provide a multiple beam system that can be utilized in raster output scanning (“ROS”) applications.

### BACKGROUND

Printbar type imager assemblies consist of an array, usually linear, of individual sources. These printbars are typically made up of smaller sub-arrays butted side by side to make a longer array. The prevalent technology currently is the light emitting diode (“LED”) bar. The individual LEDs emit a large cone of light, so arrays of SELFOC 1:1 (“self-focusing optical” transmitter glass, Nippon Sheet Glass, Japan) relay lenses must be used to image the array onto a photoreceptor (P/R) to prevent crosstalk caused by mixing of light coming from different elements of the LED array. However, for large throughput requirements and high imaging resolutions the depth of focus becomes impractically small.

Solid state semiconductor lasers are important devices in optoelectronic communication systems and high-speed printing. Recently, there has been increased interest in vertical cavity surface emitting lasers (“VCSELs”), although edge emitting lasers are currently used in the majority of applications. The reason for the interest in VCSELs is, in part, because edge-emitting lasers produce a beam with a large angular divergence, making efficient collection of the emitted beam more difficult. VCSELs, in comparison, emit a relatively narrow cone of light. The emitted beam closely approximates a gaussian laser beam. Because of this characteristic no intermediary imaging lens array is theoretically necessary. The photoreceptor does not have to be as close to the array when using a VCSEL array to prevent crosstalk of light between individual VCSEL elements as it does with conventional LED. However, this working distance will still be small and in some cases may be impractical. In addition, the waist of the VCSEL beam is coincident with the surface of the laser, so the depth of focus of the beam will not be as great as when the waist of the beam occurs at the photoreceptor plane. At the photoreceptor the beams are usually required to overlap at or in the neighborhood of their 50% intensity points. The larger the angle of the radiation cone is, the larger the divergence angle of the beams at their 50% intensity points will be and, therefore, the spot size will change rapidly as one moves away from this point along the beam. Thus, the depth of focus will be small.

Another problem that exists with current VCSEL technology is that the spacing between individual elements of the array becomes smaller as the imaging resolution requirements get higher. To prevent thermal and electrical crosstalk the source size must decrease as the source spacing decreases. Reducing the source size reduces the beam size at the VCSEL surface and increases the cone of emitted light, which compounds the problems described previously.

Thus, a need clearly exists for a printbar assembly that will yield a larger depth of focus and a larger working distance between the printbar and the photoreceptor. Moreover, it would be advantageous if such a system or device also reduced source sizes to reduce the possibility of thermal and electrical crosstalk, and could be utilized in raster output scanning applications.

### SUMMARY OF THE INVENTION

A micro-optic light emitting array includes a plurality of vertical cavity surface emitting lasers, where each vertical cavity surface emitting laser is focused with a micro-optic element.

A laser printbar imager assembly has a plurality of micro-optic vertical cavity surface emitting laser light emitting arrays as described above.

A xerographic printing system has a laser printbar imager assembly including a plurality of micro-optic light emitting arrays as described above, which emits a plurality of laser light beams, a photoreceptor for receiving the emitted light and for holding a charge image, and xerographic developer for applying toner to the charged areas of the photoreceptor created by exposure to the emitted light from the laser printbar imager assembly.

A multifunctional laser printing system having a laser printbar imager assembly including a plurality of micro-optic light emitting arrays as described above.

The present invention provides a device for xerographic laser printing capable of a practical working distance between a printbar and a photoreceptor while providing a larger depth of focus than current xerographic LED printbar technology provides. Additionally, the present invention allows for reduced source size, resulting in reduced thermal and electrical crosstalk at the image plane. The printbar of the present invention can also be used in a raster output scanning system, thus providing a high-speed, high-quality printing system.

### BRIEF DESCRIPTION OF THE DRAWINGS

FIG. 1 shows a top view of a micro-optic/VCSEL 1-D array.

FIGS. 2A-D show a front view of different embodiments of the VCSEL/micro-optic laser printbar according to the present invention. FIG. 2A shows a laser array printbar made of a plurality of VCSEL/micro-optic arrays in a side-butted linear arrangement situated on a rectangular substrate. FIG. 2B shows a front view of a laser array printbar made of a plurality of VCSEL/micro-optic arrays in an embodiment of a side-butted linear arrangement situated on a parallelogram-shaped substrate. FIG. 2C shows a front view of a laser array printbar made of a plurality of VCSEL/micro-optic arrays in a staggered arrangement situated on a rectangular. FIG. 2D shows a front view of a laser array printbar made of a plurality of VCSEL/micro-optic arrays in another embodiment of a staggered arrangement situated on a rectangular substrate.

FIG. 3 shows a perspective view of a parallelogram patterned 2-dimensional array of VCSEL/micro-optic arrays in a diagonal arrangement having four rows and four columns of VCSELs.

FIG. 4A-B show a perspective view of a subsection of an array printbar made up of parallelogram patterned 2-D VCSEL/micro-optic arrays and their corresponding images at the P/R plane.

FIG. 5A-B show a perspective view of subsection of array printbar made up of rectangular patterned 2-D VCSEL/micro-optic arrays and their corresponding images at the P/R plane.

### DETAILED DESCRIPTION OF THE INVENTION

A VCSEL is a laser device made of a plurality of semiconductor layers formed upon a substrate and capable of emitting a laser beam of a selected wavelength and a selected polarization. U.S. Pat. No. 5,978,408, issued Nov. 2, 1999, and U.S. Pat. No. 6,208,681, issued on Mar. 27, 2001, both entitled “Highly Compact Vertical Cavity Surface Emitting Lasers,” and U.S. Pat. No. 6,002,705, issued Dec. 14, 1999, and entitled “Wavelength and Polarization Multiplexed Vertical Cavity Surface Emitting Lasers,” all of which are assigned to the same assignee as the present invention, teach the formation of highly compact and well-defined VCSELs.

U.S. Pat. No. 6,116,756, entitled “Monolithic Scanning Light Emitting Devices,” issued Sep. 12, 2000, and assigned to the same assignee as the present invention, teaches the making of micro-machined movable light emitting assemblies formed on or from III-V substrates, including Vertical Cavity Surface Emitting Lasers (VCSELs).

All of the above references are hereby incorporated by reference in their entirety.

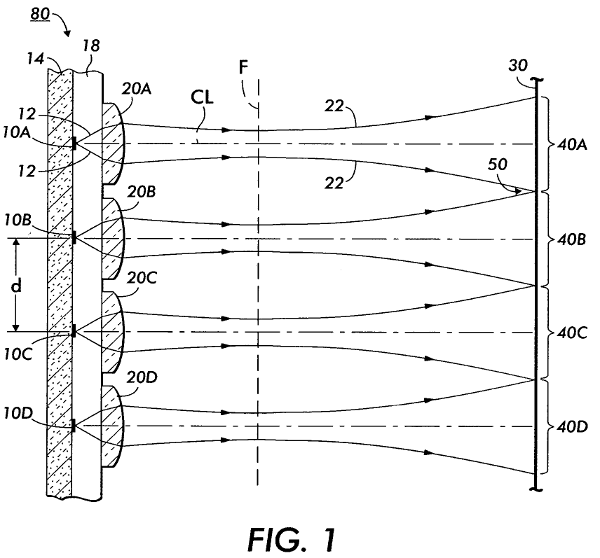

FIG. 1 illustrates one embodiment of the laser printbar 80 of the present invention including a single linear VCSEL array 14 having micro-optic lenses (micro-optics) 20A-D to provide a multiple beam system that can be utilized in printing systems, in particular, printing systems having a raster output scanning function. In FIG. 1 the laser printbar 80 is a 1-dimensional (1-D) configuration having a single linear array 14 of VCSELs 10A-D, each VCSEL 10A-D having a micro-optic focusing element 20A-D. The gap 18 between the VCSEL array 14 and the micro-optics 20A-D indicate that an air space may be left between the VCSEL array 14 and the micro-optics 20A-D in some embodiments. Alternatively, in another embodiment of the present invention there is no space between the VCSEL array 14 and the micro-optics 20A-D, rather, another material inserted between the VCSEL array 14 and the micro-optics 20A-D. In the embodiment illustrated in FIG. 1 a photoreceptor (P/R) 30 is placed approximately where the 50% intensity spot diameters or FWHM (Full Width at Half Maximum) produces spot sizes 40A-D having some overlap. In practice, adjacent spots may overlap at their 10% or higher intensity points at the P/R 30. The beams 12 emitted by the VCSELs 10A-D having a center line CL are closely approximated by gaussian beams and, therefore, the equations governing gaussian beam propagation are used to calculate magnification and object and image locations. In the embodiment shown in FIG. 1, the 50% intensity beam contours 22 fall between the micro-optic image plane F and the photoreceptor (P/R) 30. Adjacent beams overlap at 50% intensity points 50 at the photoreceptor 30. The P/R plane 30 is positioned thus to avoid gaps between the spots at the P/R and, therefore, on the recorded image.

A “VCSEL array” within the context of this invention is understood to be an individual semiconductor chip having multiple light emitting lasers 10A-D that provide either a straight line of beams or a staggered line of beams, i.e., the VCSELs are arranged within the array 14 so that the individual laser sources form a diagonal at the image plane of the micro-optics F. One or more such arrays 14 make up a laser printbar 80 of the present invention.

By “micro-optics” within the context of this specification, an optical arrangement is understood to have small-size optical component parts, for example, lenses having a diameter of tens of micrometers to a few millimeters. The lenses of the micro-optics 20A-D are standard in the art. The optical properties of a given lens is determined by the focal length and diameter, etc., desired, and one skilled in the art will appreciate that those features vary depending on the raster frequency desired (e.g., 330 SPI vs. 600 SPI). The optical surfaces of the micro-optics can be spherical, aspherical, planar, rotationally symmetric, or rotationally asymmetric. The micro-optics 20A-D can be incorporated during the fabrication of a VCSEL or added as desired to VCSELs after fabrication.

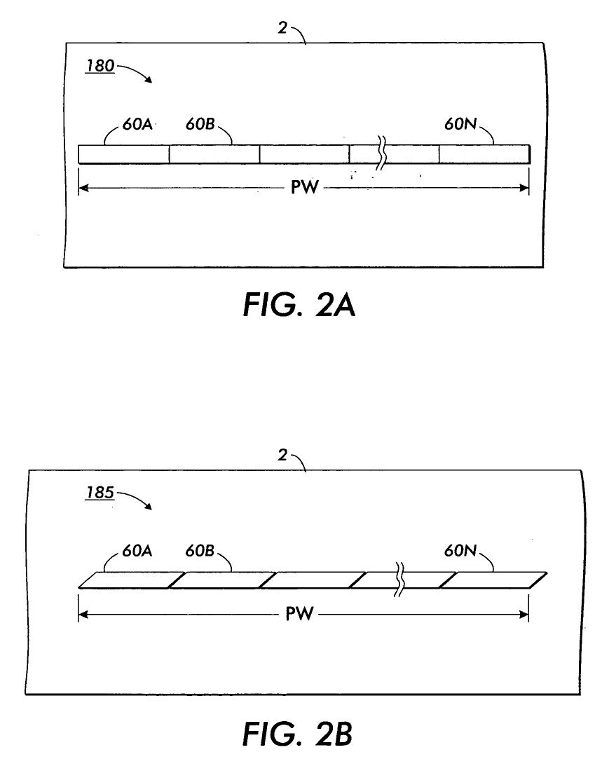

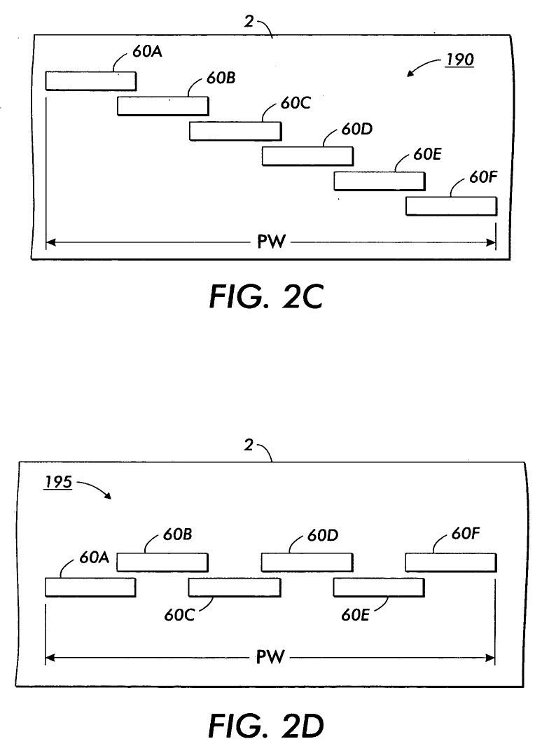

FIG. 2A illustrates an embodiment of the laser printbar of the present invention with the laser printbar 180 having a plurality of VCSEL-micro-optic arrays 60A-B, 60N arranged in a side-butted configuration along the print-width PW to provide cumulatively a linear printbar configuration on a rectangular substrate. FIG. 2B illustrates an embodiment of the laser printbar 185 of the present invention having a plurality of VCSEL-micro-optic arrays 60A-B, 60N arranged in a side-butted configuration along the print-width PW on a diagonal substrate. FIG. 2C illustrates an embodiment of the laser printbar of the present invention with the laser printbar 190 having a plurality of VCSEL-micro-optic arrays 60A-F arranged in a staggered fashion, providing a diagonal configuration relative to the print-width PW on a rectangular substrate. FIG. 2D illustrates an embodiment of the laser printbar of the present invention with the laser printbar 195 having a plurality of VCSEL-micro-optic arrays 60A-F arranged in a variation of the staggered configuration of FIG. 2B along the print-width PW, on a rectangular substrate. In FIG. 2A-D the VCSEL-micro-optic arrays 60A-F, 60N of the laser printbar 180, 185, 190, 195 are provided on a substrate 2 that provides structural stability for the arrays and may also provide electrical connectivity to other devices or systems. A typical substrate would be a printed circuit board assembly (PCBA) or printed wiring board assembly (PWBA). A substrate may be configured in a variety of shapes, including, without limitation, a rectangle, a square, and a parallelogram. The arrays 60A-F, 60N would be mounted and attached to the substrate 2 by adhesive bonding, soldering, or other suitable fastening means.

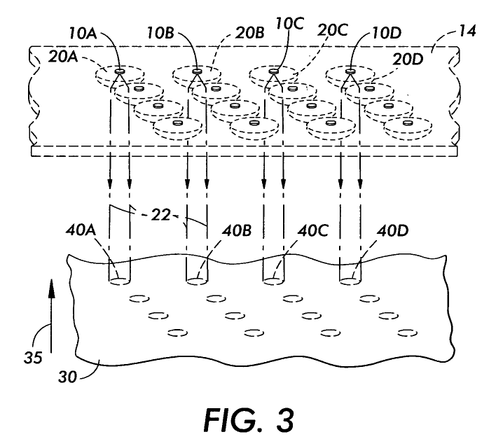

FIG. 3 is perspective view of a parallelogram patterned 2-dimensional (2-D) array 14 of VCSELs 10A-D focused with micro-optics 20A-D. In this embodiment of the present invention the photoreceptor (P/R) 30 is coincident with the image plane of the micro-optics, i.e, approximately where the waists of the imaged beams 22 are located. The process direction 35 is the direction on which the recording medium, e.g., photoreceptor 30, is moving under a stationary printhead. The row firing order (from first in time to last in time) needed to write a straight line perpendicular to the process direction occurs in the process direction. In embodiments of the present invention having a staggered VCSEL configuration the row spacing is not equal to the spot separation at the P/R (BSₚᵣ). A 2-D configuration as illustrated in FIG. 3 provides maximal depth of focus without having gaps in the recorded image.

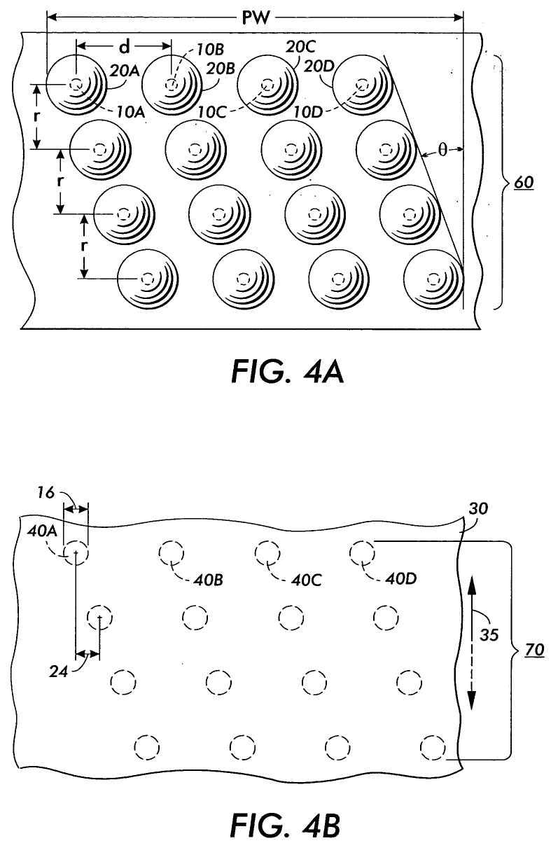

FIGS. 4A-B provide a perspective view of a parallelogram patterned 2-dimensional array 60 of VCSELs 10A-D focused with micro-optics 20A-D on a substrate 2. In this embodiment of the present invention the photoreceptor (P/R) 30 is coincident with the image plane of the micro-optics 70, where the waists of the imaged beams 22 are located. In FIG. 4A the distance between rows of emitters r is not equal to the spot separation at the P/R 24 because the array 60 is a staggered VCSEL configuration. As shown in FIG. 4B, the spot size at the P/R 40A-D is equal to the FWHM at the P/R 16. The process direction 35 is the direction on which the recording medium, e.g., photoreceptor 30, is moving under a stationary printhead. The process direction 35 is shown as bi-directional (arrow) in FIG. 3 to illustrate that the present invention encompasses embodiments wherein the P/R 30 moves in the direction indicated by the solid arrow and those wherein the P/R 30 moves in the direction indicated by the dashed arrow. θ is defined as the arc tangent of the spot separation at the P/R 24 divided by r. The row firing order (from first in time to last in time) needed to write a straight line perpendicular to the process direction occurs in the process direction. In the embodiment illustrated in FIG. 4A-B the timing between row firing (t) depends on the row spacing (r) and the velocity (v) of the photoreceptor, t=r/v. A two-dimensional configuration such as that illustrated in FIG. 4A-B provides maximal depth of focus without having gaps in the recorded image.

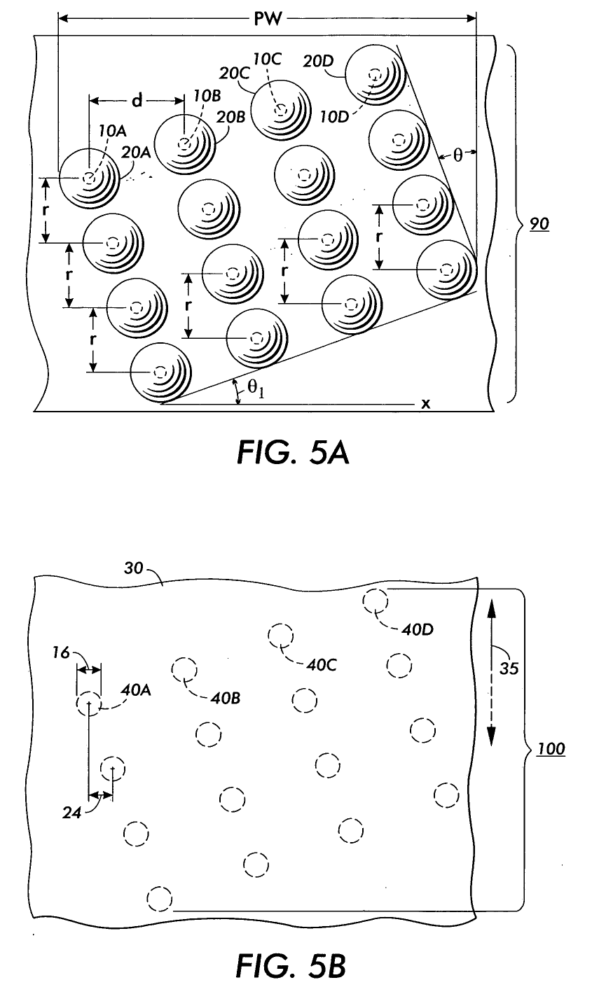

FIGS. 5A-B illustrate a rectangular patterned 2-dimensional array 90 of VCSELs 10A-D focused with micro-optics 20A-D in which the photoreceptor (P/R) 30 is coincident with the image plane of the micro-optics 100 and the waists 22 of the imaged beams. In this embodiment the VCSELs 10A-D are arranged within the array so that the individual laser sources 10A-D form a diagonal at the image plane of the micro-optics 100. The distance between rows of emitters r is not equal to the spot separation at the P/R (BSₚᵣ) 24 because the array is a staggered VCSEL configuration. As shown in FIG. 4B, the spot size at the P/R 40A-D is equal to the FWHM at the P/R 16.

The highly staggered arrangement of the VCSELs in FIG. 5A results in an angle θ₁ formed by the forward row of emitters and the edge x of the microchip perpendicular to the process direction, which may be, but is not necessarily, the same as θ. θ₁ can actually have any arbitrary value as long as the lasers in one diagonal do not physically interfere with the VCSELs in an adjacent diagonal, and the beam spacing at the photoreceptor remains the same. The 2-D array shown in FIG. 4A represents the embodiment where θ₁=0. In FIG. 5A, θ₁=0 as the array is in a rectangular configuration. The value of the micro-optics 20A-D is derived from its ability to (1) image the beams which can increase the depth of focus, and also allow the working distance between the laser printbar 180, 185, 190, 195 and the photoreceptor 30 to be increased to a more practical distance and (2) magnify the spot size of each beam 40A-D in the array without altering the separation d between the individual laser sources 10A-D of the array 90.

In embodiments of the present invention each beam 12 is imaged individually with a micro-optic 10A-D to achieve a larger spot size 40A-D, which reduces the divergence angle of the beam, thereby yielding a larger depth of focus and a larger working distance between the printbar 80 and the photoreceptor (P/R) 30. In addition, because the beam size can be magnified without changing the separation between beams, the source sizes can be made smaller to reduce the possibility of thermal and electrical crosstalk.

The present invention encompasses a xerographic laser printing system having a laser printbar imager assembly including a plurality of micro-optic light emitting arrays as described above, which emits a plurality of laser light beams, a photoreceptor for receiving the emitted light and for holding a charge image, and xerographic developer for applying toner to the charged areas of the photoreceptor produced by exposure to the emitted light from the printbar imager assembly. A laser printer, a laser facsimile machine, and a laser digital copier that includes the laser printbar imager assembly of the invention are examples of xerographic systems encompassed by this embodiment of the invention.

In embodiments of the present invention, the xerographic printing system of the present invention has a photoreceptor that is placed at or near a position where 50% intensity spot diameters spot sizes are equal to the raster spacing on the photoreceptor, although it may be placed at or near other positions, such as where greater than 50%, but less than 90%, intensity spot diameters or spot sizes are equal to the raster spacing on the photoreceptor, or where greater than 10% but less than 50% intensity spot diameters or spot sizes are equal to the raster spacing on the photoreceptor.

In another embodiment of the invention the xerographic printing system is a laser multifunction system. A laser multifunction system as used herein is meant to describe a xerographic system capable of the combined functions of a laser printer, laser scanner, and a facsimile machine in one device.

In embodiments of the present invention, the timing for switching on (“firing”) the laser emitter within a VCSEL array is arranged to further decrease the chance for overlap of the individual beams, and increase the resolution of the printed output. For example, in each array, an individual laser source in a particular location in each array is switched on (“fired”) as the print media flows past, then a laser source in a different location in each array is fired, and so on, as the paper flows from the beginning to the end of the printing process (“process direction”) 35.

Another embodiment of the invention is a laser printing apparatus having the printbar imager assembly including a plurality of micro-optic light emitting arrays as described above.

Note that if the micro-optics were not used the photoreceptor 30 would have to be located very close to the VCSEL array and that the beam divergences at the 50% points 22 would be very steep, causing the spot sizes on the photoreceptor 30 to change very rapidly with photoreceptor location.

### EXAMPLE 1

### Optical System Analysis of 1-D Printbar Using Micro-Optics

A 1st order optical system analysis example of a linear VCSEL array with micro-optics follows. The example is calculated using standard Gaussian beam propagation equations applied to a VCSEL 1-D printbar with a desired print resolution of 600 DPI, where the VCSEL laser emitters of the array have a wavelength of 780 nm, and the VCSEL has a spot size at FWHM of approximately 4.415 μm.

FWHM_{VCSEL}=˜4.415 μm

Cross process direction raster frequency=Rₓₚ=600 SPI

Spot separation=1/Rₓₚ=Raster Spacing on P/R=42.3 μm

Magnification of micro-optic=−4

Focal length of micro-optic=226.6 μm

Diameter of micro-optic lens=46 μm to 62 μm

VCSEL to micro-optic distance=226.6 μm

FWHM at micro-optic image plane=17.7 μm

Micro-optic to micro-optic image plane=226.6 μm

Micro-optic image plane to P/R plane=1.974 mm

FWHM at P/R=42.3 μm

±10% spot size depth of focus˜±239 μm

VCSEL printbar with micro-optics to P/R distance=2.201 mm

### EXAMPLE 2

### Comparative Example without Micro-Optics

A 1st order optical system analysis example of a linear VCSEL array without micro-optics having all other system design parameters as described in Example 1 follows:

VCSEL printbar P/R distance=0.54 mm

±10% spot size depth of focus˜±55 μm

As shown in Examples above, the critical parameters including depth of focus, spot separation relative to the VCSEL spot size, and micro-optic lens diameter relative to spot separation become impracticable and, in some cases, physically impossible for raster frequencies>600 SPI (“scans per inch”).

For raster frequencies>600 SPI, one practical printbar solution is found in using 2-D VCSEL arrays with micro-optics, as described herein. If the photoreceptor 30 could be placed at the micro-optic image plane F the depth of focus would be maximized (˜2.9 mm @ 600 DPI) and spot size variation would be minimized relative to variation in photoreceptor location. This can be achieved if two-dimensional arrays with staggered elements are used as shown in FIG. 3, FIG. 4, and FIG. 5. The diameter of the micro-optic element 10A-D needs to be at or about 2.5 to 4.0 times larger than the FWHM of the laser beam at the micro-optic to insure that the lens does not clip the beam. It is best if there is substantially no overlap of the micro-optics. Therefore, the number of beams per column in the array projected along the process direction will be approximately 3 or higher, regardless of the geometry (i.e., side-butted or staggered configuration) of the 2-dimensional array.

### EXAMPLE 3

### Optical System Analysis of 2-D Printbar Using Micro-Optics

The mathematical relationships for 2-dimensional VCSEL arrays such as those illustrated in FIG. 3, FIG. 4, and FIG. 5 are as follows:

Rₓₚ=raster frequency perpendicular to process direction

BSₚᵣ=1/Rₓₚ

m=magnification of micro-optics

m=FWHMₚᵣ/FWHM_{VCSEL}

Nₚ=# of beams per column in array

Nₚ=d/BSₚᵣ

For beam crossover at 50% intensity points: FWHMₚᵣ=BSₚᵣ

For crossover at beam intensity points<50%: FWHMₚᵣ<BSₚᵣ

For crossover at beam intensity points>50%: FWHMₚᵣ>BSₚᵣ

θ=arcsin(d/(r Nₚ))

An exemplary 1st order optical system analysis example of a 2-D VCSEL printbar array similar to those shown in FIGS. 3-5, but having five rows of micro-optics follows. The example is calculated using standard Gaussian beam propagation equations applied to a VCSEL 2-D printbar with a desired print resolution of 1200 DPI, where the VCSEL laser emitters have a wavelength of 780 nm, the VCSEL has a spot size at FWHM of approximately 1.177 μm, and r=d=105.83 μm:

Number of rows=5

FWHM_{VCSEL}=1.177 μm

Wavelength of VCSEL=780 nm

Process direction raster frequency=Rₓₚ=1200 scans per inch

Spot separation=1/Rₓₚ=Raster Spacing on P/R=21.17 μm

Magnification of microoptic=−17.98

Focal length of microoptic=102.4 μm

Diameter of microoptic lens=80 μm to 100 μm

FWHM at P/R=21.17 μm

±10% spot size depth of focus˜±597 μm

VCSEL printbar with microoptics to P/R distance=1.404 mm

Note the larger depth of focus as compared with 1-D VCSEL Printbar described above in Example 1, even though resolution has increased from 600 DPI to 1200 DPI.

Other modifications of the present invention may occur to those skilled in the art subsequent to a review of the present application, and these modifications, including equivalents thereof, are intended to be included within the scope of the present invention. Further, the recited order of processing elements or sequences, or the use of numbers, letters, or other designations therefore, is not intended to limit the claimed processes to any order except as may be specified in the claims.

1. A micro-optic light emitting array comprising a plurality of vertical cavity surface emitting lasers, wherein each vertical cavity surface emitting laser emits a laser beam focused with a micro-optic element.

2. The micro-optic light emitting array according to claim 1, wherein the micro-optic element has a diameter up to about 2.5 to 4.0 times larger than Full Width at Half Maximum of the emitted laser beam at the micro-optic element.

3. The micro-optic light emitting array according to claim 1, wherein the plurality of vertical cavity surface emitting lasers are arranged in a one-dimensional configuration.

4. The micro-optic light emitting array according to claim 1, wherein the plurality of vertical cavity surface emitting lasers are arranged in a two dimensional configuration.

5. The micro-optic light emitting array according to claim 4, wherein the two dimensional configuration includes rows and columns.

6. The micro-optic light emitting array according to claim 5, wherein the rows and columns are linear along a process direction.

7. The micro-optic light emitting array according to claim 5, wherein the rows and columns are staggered along a process direction.

8. A laser printbar imager assembly comprising a plurality of micro-optic light emitting arrays according to claim 1.

9. The laser printbar imager assembly according to claim 8, wherein the plurality of micro-optic light emitting arrays are arranged in a one-dimensional configuration.

10. The micro-optic light emitting array according to claim 1, wherein the plurality of vertical cavity surface emitting lasers are arranged in a two-dimensional configuration.

11. The micro-optic light emitting array according to claim 10, wherein the two-dimensional configuration includes rows and columns.

12. The micro-optic light emitting array according to claim 11, wherein the rows and columns are linear along a process direction.

13. The micro-optic light emitting array according to claim 11, wherein the rows and columns are staggered along a process direction.

14. The laser printbar imager assembly according to claim 8, wherein the lasers within a particular array are switched on at different times.

15. A xerographic printing system comprising:
a laser printbar imager assembly including a plurality of micro-optic light emitting arrays including a plurality of vertical cavity surface emitting lasers, wherein each vertical cavity surface emitting laser emits a laser beam focused with a micro-optic element;
a photoreceptor which receives said emitted light and holds a charge image; and
xerographic developer which applies toner to charged or uncharged areas of said photoreceptor produced by exposure to emitted light from the laser printbar imager assembly.

16. The xerographic printing system according to claim 15, wherein the plurality of vertical cavity surface emitting lasers are arranged in a one dimensional configuration, and the photoreceptor is placed where the beams of at least some of the plurality of vertical cavity surface emitting lasers overlap.

17. The xerographic printing system according to claim 15, wherein the laser printbar imager assembly comprises a plurality of micro-optic light emitting arrays arranged in a two dimensional configuration along a process direction.

18. The xerographic printing system according to claim 17, wherein the two dimensional configuration consists of rows and columns.

19. The xerographic printing system according to claim 18, wherein the rows and columns are in a linear configuration along a process direction.

20. The xerographic printing system according to claim 18, wherein the rows and columns are in a staggered configuration along a process direction.

21. The xerographic printing system according to claim 18, wherein the number of beams per column in the array along a process direction is 3 or greater.

22. The xerographic printing system according to claim 17, wherein the photoreceptor is placed at or near a position where 50% intensity spot diameters or spot sizes are equal to the raster spacing on the photoreceptor.

23. The xerographic printing system according to claim 17, wherein the photoreceptor is placed at or near a position where greater than 10% but less than 50% intensity spot diameters or spot sizes are equal to the raster spacing on the photoreceptor.

24. The xerographic printing system according to claim 17, wherein the photoreceptor is placed at or near a position where greater than 50% but less than 90% intensity spot diameters or spot sizes are equal to the raster spacing on the photoreceptor.

25. The xerographic printing system according to claim 15, wherein there is substantially no overlap of the micro-optic focusing elements.

26. The xerographic printing system according to claim 15, further comprising a raster output scanner.

27. The xerographic printing system according to claim 16, wherein the xerographic printing system is a laser multifunction system.
